(19) United States
(12) Patent Application Publication
(10) Pub. No.: US 2026/0330570 A1
(43) Pub. Date: Oct. 22, 2026

(54) SYSTEMS AND METHODS FOR A HYBRID CONTROLLABLE LOAD RESOURCE

(71) Applicant: Inventus Holdings, LLC, Juno Beach, FL (US)

(72) Inventors: Besith J. Pineda, Washington, DC (US); Marcelo O. Aguiar, Juno Beach, FL (US); Neeti Rastogi, Toronto (CA); Sudipta R. Lahiri, Boynton Beach, FL (US); Jeffrey T. Plew, Stuart, FL (US)

(21) Appl. No.: 19/185,027

(22) Filed: Apr. 21, 2025

(51) Int. Cl. G06Q 50/06; G06Q 40/04

(52) U.S. Cl. CPC G06Q 50/06; G06Q 40/04

(57) ABSTRACT

The disclosed technology includes systems and methods for operating a hybrid controllable load resource. The disclosed technology includes a method for operating a hybrid controllable load resource including receiving input data. The method includes generating a market offer based at least in part on the input data. The method includes submitting the market offer to a market clearing engine of a grid operator. The method includes receiving a dispatch from the market clearing engine. The method includes determining at least one of an optimal load operating setpoint and an optimal energy storage operating setpoint based at least in part on the dispatch. The method includes updating at least one of a load operating setpoint of the load resource to the optimal load operating setpoint and an energy storage operating setpoint of the energy storage resource to the optimal energy storage operating setpoint.

### FIELD OF THE DISCLOSURE

The various embodiments of the present disclosure relate generally to controllable load resources and the demand-response market, and more particularly to systems and methods for operating a hybrid controllable load resource including a load resource and energy storage resource.

### BACKGROUND

Rapid growth of the electric grid, expanding data center demand, and evolving regulation are creating a need for solutions for balancing grid stability, meeting increasing energy demands, and leveraging new market opportunities. Grid operators, such as The Electric Reliability Council of Texas (ERCOT), have attempted to address these considerations by implementing new forms of energy trade to enable power generators, generation companies, generation site managers, and the like to satisfy this new demand in the market. One such form is a controllable load resource (CLR), which allows a grid operator and/or generator to adjust a load of an electrical load resource connected to the electric grid based on supply and demand of energy within the electric grid. The CLR provides improved grid stability, significant cost savings, and grid flexibility to enable further development of renewable energy sites.

However, integration of CLR's has proven difficult due to technical and regulatory barriers. For example, eligibility requirements, market structures, technical requirements for interconnection, approval processes, consumer data protection, dynamic pricing, inflexible tariffs, etc. complicate CLR development and operation. Further, large loads such as data centers are characterized by substantial power demand, limited flexibility, strict reliability and uptime requirements, and significant economic considerations which constrain the ability for use as a CLR.

Accordingly, there is a need for improved systems and methods for operating a controllable load resource to accommodate larger loads. Embodiments of the present disclosure are directed to this and other considerations.

### BRIEF SUMMARY

To achieve the above-described method of operating a controllable load resource, the disclosed technology includes a method for operating a hybrid controllable load resource. The method can include receiving input data. The input data can include energy market price forecast data, ancillary service market price forecast data, load forecast data, peak demand forecast data, transmission cost forecast data, real-time demand data from a load resource, real-time health data from an energy storage resource, real-time state of charge data from the energy storage resource, or any combination thereof. The method can include generating a market offer. The market offer can be generated based at least in part on the input data. The method can include submitting the market offer to market clearing engine of a grid operator. The method can include receiving a dispatch. The dispatch can be received from the market clearing engine. The method can include determining at least one of an optimal load operating setpoint and an optimal energy storage operating setpoint. At least one of the optimal load operating setpoint and the optimal energy storage operating setpoint can be determined based at least in part on the dispatch. The method can include updating at least one of a load operating setpoint of the load resource and the energy storage operating setpoint of the energy storage resource. The load operating setpoint of the load resource can be updated to the optimal load operating setpoint, and the energy storage operating setpoint of the energy storage resource can be updated to the optimal energy storage operating setpoint.

According to another aspect of the present disclosure, the disclosed technology includes a system for operating a hybrid controllable load resource of an electric grid, in which a data center can be electrically connected to the electric grid and can be configured to dynamically alter a load based at least in part on a dispatch from a grid operator and a battery energy storage system (BESS) can be electrically connected to the data center and can be configured to provide ancillary services to the electric grid. The system can include an offer generation system configured to generate a market offer. The market offer can be generated by the offer generation system based at least in part on a real-time data center demand, real-time health of the BESS, real-time state of charge of the BESS, or any combination thereof. The system can include a translation engine configured to update a load operating setpoint of the data center and a BESS operating setpoint of the BESS. The load operating setpoint of the data center and the BESS operating setpoint of the BESS can be updated by the translation engine based at least in part on the dispatch.

The disclosed technology can additionally include a method for operating a hybrid controllable load resource of an electric grid. The method can include receiving input data. The input data can include forecasted input data, real-time demand data of a data center of the hybrid controllable load resource, real-time health data of a battery energy storage system (BESS) of the hybrid controllable load resource, and real-time state of charge data of the BESS. The forecasted input data can include market price forecast data, ancillary services market price forecast data, data center load forecast data, peak demand forecast data, transmission cost forecast data, or any combination thereof. The method can include generating one or more market offers. The one or more market offers can be generated based at least in part on the input data. The one or more market offers can include at least one of a market offer for an energy market and an ancillary service offer for an ancillary service market. The method can include submitting the one or more market offers to one or more market clearing engines of a grid operator. The method can include receiving a dispatch including at least one of a load dispatch and an ancillary service dispatch. The method can include updating at least one of a load operating setpoint of the data center and an energy storage operating setpoint of the BESS. At least one of the load operating setpoint of the data center and the energy storage operating setpoint of the BESS can be updated based at least in part on at least one of the load dispatch and the ancillary service dispatch.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates an example system for operating a hybrid controllable load resource, in accordance with an example of the disclosed technology.

FIG. 2 illustrates an example system for operating a hybrid controllable load resource, in accordance with an example of the disclosed technology.

FIG. 3 illustrates an example system for operating a hybrid controllable load resource, in accordance with an example of the disclosed technology.

FIG. 4 is a flow diagram illustrating a method for operating a hybrid controllable load resource, in accordance with an example of the disclosed technology.

FIG. 5 is another flow diagram illustrating a method for operating a hybrid controllable load resource, in accordance with an example of the disclosed technology.

FIG. 6 illustrates an example computing device configured to operate a hybrid controllable load resource, in accordance with an example of the disclosed technology.

### DETAILED DESCRIPTION

The disclosed technology relates generally to systems and methods for operating a hybrid controllable load resource. As understood by those skilled in the art, some grid operators allow for controllable load resources, which dynamically alter a load based on dispatches from the grid operator. The controllable load resources receive market awarded load dispatches based on acceptance and rejection of market offers made for a load. In this way, the market awarded load may fluctuate in time, as some market offers can be rejected, and some can be accepted over a given period of time. Additionally, in some cases, a controllable load resource can be a resource, such as a data center, characterized by a large load and corresponding demand from customers of the controllable load resource. The large load needed to meet demand for these resources can make it difficult for a resource such as a data center to properly meet demand while operating as a controllable load resource.

The disclosed technology provides a novel construct in the form of a hybrid controllable load resource. The hybrid controllable load resource can operate as a controllable load resource with respect to interactions with the grid operator, in that the hybrid controllable load resource can be configured to generate market offers, receive market awards and/or dispatches, and adjust load based on the market awards. That is, the hybrid controllable load resource can dynamically respond to real-time dispatches for energy, load, ancillary services, and the like from grid operators. The hybrid controllable load resource can include at least a load resource and an energy storage resource, electrically connected and in some embodiments collocated. In this way, the load resource and the energy storage resource can operate as a single entity in the form of a controllable load resource (a “hybrid” controllable load resource).

To consistently meet demand for the load resource and maximize a monetary potential of market offers, the hybrid controllable load resource can employ novel systems and methods for generating market offers and translating dispatches into operating setpoints for the hybrid controllable load resource. For example, an optimization system can operate on behalf of the hybrid controllable load resource, such that the optimization system can submit market offers for the hybrid controllable load resource and receive and distribute dispatches to the hybrid controllable load resource. The optimization system can include an offer generation system for generating market offers and a translation engine for determining operating setpoints for the hybrid controllable load resource. The offer generation system can generate a market offer on behalf of the hybrid controllable load resource by solving an optimization problem for the market offer, in that the offer generation system can receive input data to determine an optimal market offer. The input data, as will be discussed in greater detail herein, can include some combination of forecasted data, real-time data from the hybrid controllable load resource, and user-identified constraints and parameters.

The market offer can be submitted and considered in a market clearing decision by the grid operator, outputting an acceptance or rejection of the market offer in the form of a signal, dispatch, or the like. The outcome of an acceptance decision on the market offer can be in the form of a load adjustment for the load resource, such that the hybrid controllable load resource can adjust a load consumption, or load operating setpoint, of the load resource with respect to a load received from market awards. In some cases, the market offer can be rejected, which may include a request from the grid operator for the hybrid controllable load resource to curtail load. Curtailing the load of the load resource can be such that a load received from market awards is less than a load demand for the load resource. In this instance, the hybrid controllable load resource can alter an operating setpoint of the energy storage resource accordingly to supplement the load needed by the load resource to meet demand. In this way, the hybrid controllable load resource can enable cost-effective market offer strategies, as the hybrid controllable load resource can operate to allow the load resource to meet a load demand whether market offers are accepted or rejected.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of being systems and methods for operating a hybrid controllable load resource. The present disclosure, however, is not so limited, and can be applicable in other contexts in which data is provided by a human and entered into a computing system. For example, the disclosed technology can be applicable to systems in which a human can enter data via a keyboard, a mouse, a microphone (e.g., interactive voice response (IVR)), or other devices configured to provide data from a human to a computing system. Accordingly, when the present disclosure is described in the context of systems and methods for operating a hybrid controllable load resource, it will be understood that other implementations can take the place of those referred to.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the methods and processes described herein. That is, the disclosed technology includes methods that omit one or more steps expressly discussed with respect to the methods described herein.

As used herein, the term “grid operator” can include any entity associated with the coordination, control, and monitoring of the electric grid. As non-limiting examples, a grid operator can include an independent system operator (ISO), a regional transmission organization (RTO), a load-serving entity, or vertically integrated utility. The grid operator can include any entity which receives offer bids, offers, bids, or offer prices for the sale of electricity, demand-response, ancillary services, and the like from another party and accepts or rejects one or more of the offer bids, offers, bids, or offer prices.

Reference will now be made in detail to example embodiments of the disclosed technology that are illustrated in the accompanying drawings and disclosed herein. Wherever convenient, the same reference numbers will be used throughout the drawings to refer to the same or like parts.

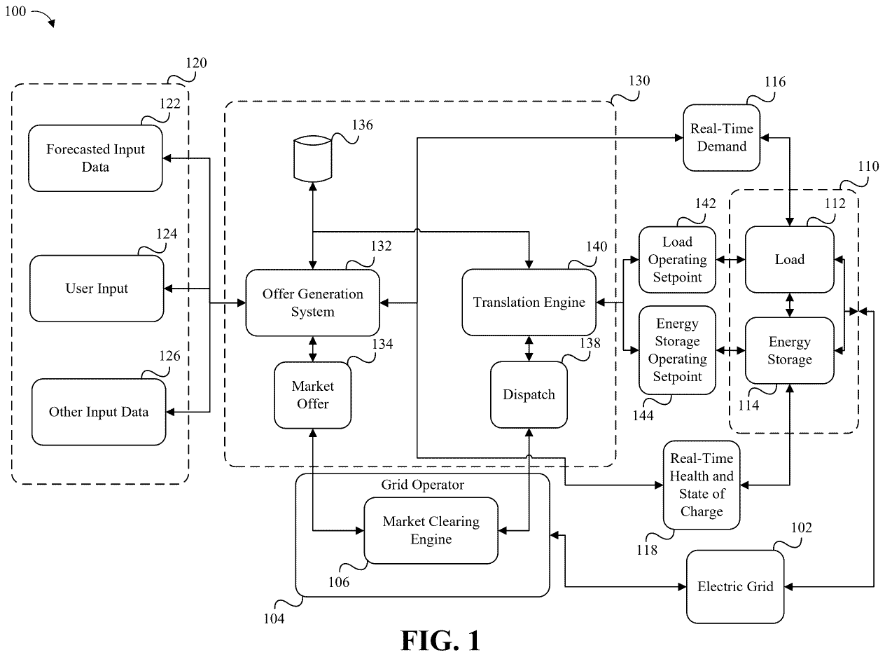

FIG. 1 illustrates an example system 100 for operating a hybrid controllable load resource of an electric grid. One of skill in the art will appreciate that the various features of the system 100 described herein can be incorporated into a single computing device or be divided into distinct parts across a network of computing devices. Thus, although the various features of the system 100 may be described as separate and distinct features or components, the described technology is not so limited.

The system 100 can include an electric grid 102. As can be appreciated, the system 100 can be configured to be implemented within the electric grid 102, and does not necessarily include the electric grid 102 in its entirety. For example, the system 100 can include a portion of the electric grid operated by a grid operator 104. Stated otherwise, the system 100 can be configured to operate within a region operated by one or more grid operators, including at least the grid operator 104. The grid operator 104 can include any independent system operator (ISO), regional transmission organization (RTO), transmission system operator (TSO), distribution system operator (DSO), or similar entities as understood by those skilled in the art. For example, the grid operator 104 can include the Electric Reliability Council of Texas (ERCOT), or any entity, organization, or authority that monitors and/or controls the distribution of electricity in the electric grid 102. As discussed herein, the grid operator 104 can receive offers for electricity/energy markets, ancillary service markets, etc. and accept or reject offers based on a market clearing process. In this way, the grid operator 104 can include a market clearing engine 106 which, as will be discussed in greater detail herein, can receive offers (sometimes referred to herein as “market offers”) from power generators, independent power producers (IPPs), or the like, and distribute rewards in the form of dispatches. As will be appreciated, dispatches can include a request for load adjustment, an ancillary service request, and/or an energy dispatch.

The system 100 can include a hybrid controllable load resource 110. In some embodiments, the hybrid controllable load resource 110 can be characterized as a controllable load resource (CLR) that is further configured to internally support the controllable load. For example, as shown, the hybrid controllable load resource 110 can include a load resource 112. As can be appreciated, the load resource 112 can be a controllable load resource, such that the load resource 112 can be configured to have an operating setpoint be dynamically adjusted based on market awards, or dispatches, from a grid operator 104. Stated otherwise, the load resource 112 can be configured to dynamically adjust a load, or load consumption. The hybrid controllable load resource 110 can include an energy storage resource 114 electrically connected to the load resource 112. In some embodiments, the hybrid controllable load resource 110 can be collocated, such that the load resource 112 and the energy storage resource 114 can be collocated. That is, the hybrid controllable load resource 110, in some embodiments, can operate under a single meter, in that the load resource 112 and the energy storage resource 114 are electrically connected under a single meter. In this way, the load resource 112 and the energy storage resource 114 can be considered, in combination, a controllable load resource, such that the hybrid controllable load resource 110 can be considered a CLR for operating within the energy market, demand-response market and/or the ancillary service market. In other embodiments, the hybrid controllable load resource 110 can include a plurality of loads and/or a plurality of energy storage resources, such that the hybrid controllable load resource 110 can operate under a plurality of meters.

The energy market, as can be appreciated, can refer to a market where electricity can be bought and sold. Participants in the energy market can submit bids and offers for energy, and a grid operator (e.g., the grid operator 104) can clear the market based on supply and demand. Dispatches from the energy market can include market awards for providing or receiving load. The demand-response market, as understood herein, can refer to a market where participants can adjust electricity consumption in response to grid needs and/or price signals, such as in peak periods. Dispatches from the demand-response market can include instructions for load adjustment or curtailment. The ancillary service market can refer to a market that provides services to the electric grid 102 to maintain grid reliability and stability. Dispatches in the ancillary service market can include instructions to provide these services, as will be understood herein.

The load resource 112 can include any resource, asset, site, or the like that is electrically connected to the electric grid 102 and requires power, referred to herein as a load or load consumption, to operate. For example, the load resource 112 can include a data center, or any other large commercial and industrial load as understood in the art. As understood herein, the load resource 112 can be configured to provide a service. For example, a data center can be configured to provide data storage, telecommunication systems, hosting services, data security resources, disaster recovery services, and similar functions as understood in the art. Consequently, the load resource 112 may require a load demand to meet demand of one or more customers for which the load resource 112 provides services. The load demand, put differently, can be an energy consumption of the load resource 112 needed to meet demand of services of the load resource 112. Additionally, the load resource 112, when acting as a controllable load resource, may receive varying dispatches over time defining an awarded load, in the form of a load dispatch from market awards, from the grid operator 104. The load dispatch, as will be discussed in greater detail herein, can be a load received by the load resource 112 from the electric grid 102 as determined by the grid operator 104. As market offers are made over time, the hybrid controllable load resource 110 may receive a plurality of load dispatches over time, which may differ in time. That is, the load dispatch may be greater than, less than, or equal to a previous load dispatch. Accordingly, in some embodiments, the load dispatch can include a load adjustment value, indicating an amount of energy which the hybrid controllable load resource 110 is to increase or decrease a load by. As can be appreciated, an operating setpoint of the load demand and an operating setpoint as constrained by dispatches from the grid operator 104 may contrast. As will be discussed in greater detail herein, the hybrid controllable load resource 110 can be operated such that the load resource 112 can be configured to meet the requirements of dispatches from the grid operator 104 while operating in accordance the load demand.

The energy storage resource 114 can include any resource, asset, site, or the like that can be configured to provide ancillary services to the electric grid 102, the load resource 112, and/or any resource of the hybrid controllable load resource 110. Additionally, the energy storage resource 114 can include any example site, resource, asset, or the like of the electric grid 102 that may store, at least temporarily, energy and discharge said energy to other sites of the electric grid 102. For example, the energy storage resource 114 can include a battery energy storage resource (BESS). The energy storage resource 114 can be electrically connected to the load resource 112 such that the energy storage resource 114 can be configured to supply electricity, or power, to the load resource 112. As will be discussed herein, the hybrid controllable load resource 110 can be operated such that the energy storage resource 114 can supplement the load resource 112, in that the energy storage resource 114 can be configured to supplement market awards, or dispatches, for the load resource 112 to ensure the load resource 112 can meet customer demand when the load dispatch is less than the load demand. Stated otherwise, the energy storage resource 114 can be configured to dynamically alter an operating setpoint, the operating setpoint, as will be discussed in greater detail herein, including an energy discharge to the load resource 112, an energy discharge to the electric grid 102, an ancillary service for the electric grid 102, or any combination thereof.

The load resource 112 can be configured to generate real-time demand data 116 and communicate the real-time demand data 116 to an optimization system 130. The optimization system 130 will be discussed in greater detail herein. The real-time demand data 116, as can be appreciated, may include values, parameters, datasets, or the like, representative of the demand for energy from the load resource 112. As understood by those skilled in the art, a load resource (e.g., the load resource 112) can have one or more customers, each having demand which may vary in time. In this way, the load resource 112 can measure an aggregate demand at the load resource 112 and communicate the aggregate demand in the form of the real-time demand data 116. The real-time demand data 116 can be generated and communicated in real-time, in that the load resource 112 can be configured to output the real-time demand data 116 at regular intervals. As will be discussed in greater detail herein, the regular intervals for the output of the real-time demand data 116 can be based at least in part on an offer strategy and/or an interval for offer acceptance of the electricity market of the electric grid 102.

The energy storage resource 114 can be configured to generate real-time health and state of charge data 118 and communicate the real-time health and state of charge data 118 to the optimization system 130. The real-time health and state of charge data 118, as can be appreciated, may include values, parameters, datasets, or the like, representative of an available capacity of energy of the energy storage resource 114 and/or a health status of the energy storage resource 114. As understood by those skilled in the art, an energy storage resource (e.g., the energy storage resource 114) can be configured to discharge energy to the load resource 112 and an ancillary service market of the electric grid 102, both of which may have energy demand that varies in time. The health status of the energy storage resource 114, or state of health, can include a measure of a condition of the energy storage resource 114 expressed as a percentage of the optimal capacity and/or efficiency of the energy storage resource 114, which may be based on degradation of energy storage units of the energy storage resource 114. Additionally, the state of charge of the energy storage resource 114, as understood in the art, can include a measure of a current, or real-time, level of charge of the energy storage resource 114. In this way, the energy storage resource 114 can be configured to measure and output real-time data for determining an ability of the energy storage resource 114 to supplement the load resource 112 and/or provide ancillary services to the ancillary service market. The real-time health and state of charge data 118 can be generated and communicated in real-time, in that the energy storage resource 114 can be configured to output the real-time health and state of charge data 118 at regular intervals. As will be discussed in greater detail herein, the regular intervals for the output of the real-time health and state of charge data 118 can be based at least in part on an offer strategy, an interval for offer acceptance of the ancillary service market of the electric grid 102, and/or an interval for offer acceptance of the electricity market of the electric grid 102.

The system 100 can include input data 120. That is, the system 100 can be configured to receive input data 120 from an internal source, such as a user, forecasting system, or the like, and/or an external source, such as a grid operator (e.g., the grid operator 104), transmission authority, third-party energy company, etc. As understood by those skilled in the art, the input data 120 can be received and communicated via one or more computing devices and/or one or more of a local network, an external network, a transceiver, or similar mechanisms known in the art. In this way, although not shown, the system 100 can include a computing device configured to receive data from any data source discussed herein.

The input data 120 can include forecasted input data 122. The forecasted input data 122 can be characterized as a predictive set of data, in that the forecasted input data 122 can be representative of projections for loads, energy storage, energy output, and sources of such discussed herein. For example, the forecasted input data 122 can include energy market price forecast data (or energy market forecast data). As can be appreciated, a price of energy dictated by supply and demand of the energy market can fluctuate over time. The energy market price forecast data can include an associated volume of energy, or power, at the forecasted price for energy. In some embodiments, the energy market price forecast data can include a monetary value (e.g., dollar) per power output (e.g., megawatt hour, or MWh) and a volume being accepted specific to location. As understood by those skilled in the art, the price of energy in the market can vary by location, as the electric grid includes a number of “hubs” where electricity/energy is traded. As can be appreciated, the energy market price forecast data can be based on location, or more particularly, by grid operator and/or hub.

The forecasted input data 122 can include ancillary services market forecast data. As understood by those skilled in the art, ancillary services can be provided by generators, generation asset managers, and the like to improve grid stability and ensure that energy supply is continuously updated based on demand. For example, ancillary services can include frequency regulation, spinning reserves, non-spinning reserves, voltage support, black start capability, load following, load ramping, reactive power control, reactive voltage control, energy imbalance service, operating reserves, demand response, or similar services as understood in the art. As a non-limiting example, the ancillary services for ERCOT can include regulation up, regulation down, responsive reserve service, and ERCOT contingency reserve service. Consequently, the ancillary services market forecast data can include projected values for these services. For example, the ancillary services market forecast data can include a forecasted energy injection into the electric grid based on time, location, connected components, etc. As understood by those skilled in the art, some ancillary services include an energy output into the electric grid from a power generator, generation asset, and/or energy storage system, such as a battery energy storage system (BESS). In this way, the ancillary services market forecast data can include forecasted supply and demand values for the ancillary service market.

The forecasted input data 122 can include load resource forecast data. As can be appreciated, the load resource forecast data can include projected load operating setpoints for the load resource 112. In some embodiments, the load resource forecast data can include a forecasted load demand, in that the load resource forecast data can be based on a forecasted customer demand for services provided by the load resource. The load resource forecast data can include forecasted load values of dispatches from grid operators (e.g., the grid operator 104), such that the forecasted load values of dispatches can be indicative of how much electric power (based on location, time, etc.) will be provided to the load resource 112 by the electric grid 102. As can be appreciated, the load resource 112 may require a greater or lesser volume of electric power than is awarded via dispatches from the grid operator 104. In this way, the hybrid controllable load resource 110 can be configured to dynamically discharge electric power to and from the load resource 112 based at least in part on load resource forecast data, market awards/dispatches, available power, and other considerations discussed in greater detail herein.

The forecasted input data 122 can include peak demand forecast data. The peak demand forecast data can include projected values for a peak demand over a given period of time. Peak demand, as understood by those skilled in the art, can include a maximum value over a given period of time of the demand for electricity from the electric grid 102. The peak demand forecast data can be associated with the load resource 112, such that the peak demand forecast data can be representative of a peak load demand for the load resource 112. Additionally, the peak demand forecast data can be associated with the energy storage resource 114, such that the peak demand forecast data can be representative of a peak energy demand for the energy storage resource. As can be appreciated, the hybrid controllable load resource 110 can be configured such that the peak demand forecast data can be associated with the load resource 112 and the energy storage resource 114, in that the peak demand can be a peak load to be met by the load resource 112, the energy storage resource 114, or both.

The forecasted input data 122 can include transmission cost forecast data. The transmission cost forecast data can include projected values for a cost of energy transmission for the hybrid controllable load resource 110. As understood by those skilled in the art, the transmission cost per unit of electricity can vary, which may impact feasibility of energy generation and transmission, as well as the ability of the hybrid controllable load resource 110 to meet a demand setpoint.

The input data 120 can include user input 124. The user input 124 can include any form of input into the system 100 by a user. For example, the user input can include parameters, thresholds, or the like for market offer generation, dispatch translation, operating setpoint determination, or similar contexts as will be understood herein.

In some embodiments, the user input 124 can include user-determined constraints. The user-determined constraints can include any constraints input into the system 100 by a user so as to limit offer generation. For example, the user-determined constraints can include physical constraints, such as electrical interconnection, energy output levels, ramp rates, resource operating procedures, energy regulations, etc. The user-determined constraints can include a maximum and/or minimum offer threshold, the threshold reflecting the price of energy, the volume of energy, or both, of the offer.

The user-determined constraints can include a user specified risk. The user specified risk can be a parameter included in the input data 120 based on a cost-benefit analysis of market offer generation. As discussed herein, for some electricity markets, an offer may be accepted or rejected based on the offer's price and volume as compared to the demand of the market. As can be appreciated, if an offer is accepted, the party from which the offer originated may or may not have the ability to provide the volume of energy of the offer. In this way, the user specified risk can indicate a willingness to reduce a load of the hybrid controllable load resource 110. Similarly, in some embodiments, the user specified risk can be based on an expectation of meeting the load volume of an offer if the offer is accepted. Alternatively, the user specified risk can be based on an expectation of offer acceptance. In this way, the user specified risk alters an offer strategy, or offer generation method, by determining how conservative and/or how aggressive the offer strategy will be.

The input data 120 can include other input data 126. The other input data 126 can be related to general trends and conditions which may affect the generation and transmission of energy. For example, the other input data 126 can include location-specific data, which may reflect the availability of transmission lines, region-specific regulations, location-specific thresholds, and the like. The other input data 126 can include weather-related data, as weather conditions, (e.g., temperature trends) can affect the difficulty and cost of energy transmission. For example, the weather-related data can include temperature trends, forecasts, and associated effects on the electric grid 102 and/or the electricity market. In some embodiments, the other input data 126 can include operating data (e.g., setpoints, demand, health, efficiency, etc.) from a collocated asset of the hybrid controllable load resource 110. For example, the hybrid controllable load resource 110 can further include a generation resource collocated with the load resource 112 and the energy storage resource 114. As will be appreciated, the other input data 126 can include data indicative of operation of said generation resource to ensure the input data 120 is reflective of operation of the hybrid controllable load resource 110 as a whole.

The system 100 can include the optimization system 130 configured to receive the input data 120. The optimization system 130 can include one or more processors and memory, the memory containing instructions which when executed by the one or more processors can cause the optimization system 130 to execute the methods and processes of systems which the optimization system 130 comprises, as recited herein. Further, the optimization system 130 can operate via one or more computing devices, one or more of a local network, an external network, and the like, as will be discussed in greater detail herein.

The optimization system 130 can include an offer generation system 132 configured to generate a market offer 134. The offer generation system 132 can be configured to receive the input data 120 and generate the market offer 134 based at least in part on the input data 120. In some embodiments, the offer generation system 132 can be further configured to receive the real-time demand data 116 from the load resource 112 and/or the real-time health and state of charge data 118 from the energy storage resource 114 and generate the market offer 134 based at least in part on the real-time demand data 116 and/or the real-time health and state of charge data 118. In this way, the market offer 134 can be generated based at least in part on forecasted data and real-time data. In some embodiments, the market offer 134 can be generated by the offer generation system 132 with a goal of profit maximization. That is, the offer generation system 132 can be configured to generate the market offer 134 based on a maximization of an expected monetary function. As can be appreciated, the maximization of an expected monetary function can be constrained by one or more user-defined constraints (e.g., the user-determined constraints). Optimization techniques employed by the offer generation system 132 can include any optimization techniques understood by those skilled in the art applicable to generation of market offers in the electricity and/or ancillary service markets, or similar contexts as understood herein.

The market offer 134, as understood herein, can include a price and volume submitted to the grid operator 104. As understood by those skilled in the art, the grid operator 104 may have authority over settling offer decisions and generating offer acceptances and rejections based on market clearing methods. That is, the market offer 134 can be an offer for the sale of electricity in an electricity market, an offer for ancillary services in an ancillary services market, an offer for load in an energy market and/or demand-response market, etc. As a non-limiting example, the market offer 134 can include a load request as part of the hybrid controllable load resource 110 having the status of a controllable load resource. The market offer 134, in some embodiments can include a price for sale of electricity and a volume of electricity at the price. As can be appreciated, determining the price and the volume can present an optimization problem, as a clearing engine of a grid operator (e.g., the grid operator 104), as will be discussed in greater detail herein, may determine offer acceptances and rejections based on an intersection of supply and demand of other offer volumes and prices. In this way, the offer generation system 132 can be configured to determine the price and the volume of the market offer 134. For example, the price can be an amount expressed in dollars, or any other currency based on the location of the electric grid 102, and the volume can be an amount expressed in power times time, e.g., megawatt-hour (MWh).

The offer generation system 132 can be configured to submit the market offer 134 to a market clearing engine 106 of the grid operator 104. The market clearing engine 106 can be a market clearing system of the grid operator 104 configured to receive a plurality of offers and/or bids and determine a market clearing price based on supply and demand of the plurality of offers and/or bids. In some embodiments, the market clearing engine 106 can be a demand-side market clearing engine, in that the market clearing engine 106 can be configured to output signals, or dispatches, for electricity consumption or generation to load resources, generation resources, energy storage systems, and the like. For example, the market clearing engine 106 can be configured to determine an electricity consumption adjustment and communicate the electricity consumption adjustment in the form of a signal to a controllable load resource. In other embodiments, the market clearing engine 106 can include an electricity market clearing engine, an energy market clearing engine, a demand-response market clearing engine, an ancillary service market clearing engine, or similar markets operated by the grid operator 104 for which methods of market clearing understood in the art are employed. Similarly, the market clearing engine 106 can include multiple market clearing engines, including any combination of the market clearing engines discussed herein. As can be appreciated, the market offer 134 can be submitted to the market clearing engine 106 on behalf of the hybrid controllable load resource 110, such that any dispatches and/or market awards resultant from acceptance or rejection of the market offer 134 can be attributed to the hybrid controllable load resource 110.

The market clearing engine 106 can be configured to generate a dispatch 138. The dispatch 138, in some embodiments, can include one or more market awards based at least in part on an acceptance or rejection of the market offer 134 by the market clearing engine 106. That is, similar to examples of the market offers and/or market clearing engines, the dispatch 138 can include a load dispatch, an energy dispatch, an ancillary service dispatch, or the like, based at least in part on the type and content of the market offer 134. In some embodiments, the dispatch 138 can include a volume, a price, and an indicator of the dispatch type. As non-limiting examples, the volume can be expressed in megawatts (MW) and the price can be expressed in dollars ($). Further, the dispatch type can be based on the one or more markets of the market offer 134 and the associated offer included in the market offer 134. That is, for the energy market, the dispatch type can include an awarded load; for the ancillary service market, the dispatch type can be indicative of the type of ancillary service to be provided; and for the demand-response market, the dispatch type can include a load increase or a load curtailment. For example, the dispatch 138 can include a market award of the volume of electricity of the market offer 134 at the price of the market offer 134 if the market offer 134 is accepted and the price of the market offer 134 is a market clearing price. In some embodiments, the dispatch 138 can include a market award of the volume of electricity of the market offer 134 at a higher price than the price of the market offer 134 if the market offer 134 is accepted and the price of the market offer 134 is below the market clearing price. The dispatch 138, as understood for controllable load resources, can include any examples of load dispatches discussed herein, such that the dispatch 138 can include an amount of energy to be supplied to the hybrid controllable load resource 110 over a period of time. The amount of energy can be used by the hybrid controllable load resource 110 in the form of load for the load resource 112, in that the market awarded energy can be supplied to the load resource 112. In other embodiments, the dispatch 138 can include instructions to curtail load consumption if the market offer 134 is rejected. The dispatch 138, as can be appreciated, can be a dispatch for the hybrid controllable load resource 110, such that volume of energy awarded by the dispatch 138 can be received by the hybrid controllable load resource 110.

In some embodiments, the dispatch 138 can include a security-constrained economic dispatch (SCED). As understood by those skilled in the art, a SCED can include an optimization process used by the grid operator 104 to determine a most cost-effective dispatch of available generation resources, while ensuring the system operates within security constraints, such as transmission limits and reliability standards. In some cases, SCED can account for various constraints, including but not limited to transmission line capacities, generation limits, and reliability requirements. Said various constraints can ensure that the electric grid 102 operates securely while dispatching resources economically. In this way, SCED can be used for any market discussed herein. That is, the dispatch 138 can include the SCED when the dispatch is for the energy market, the demand-response market, the ancillary service market, or any combination thereof. Accordingly, the SCED, in some embodiments, can ensure the economical and secure of operation of the hybrid controllable load resource 110 within the markets described herein.

The optimization system 130 can include a translation engine 140 configured to receive the dispatch 138 from the market clearing engine 106. The translation engine 140 can be in communication with the hybrid controllable load resource 110, such that the translation engine 140 can be configured to alter operating setpoints of the hybrid controllable load resource 110 via output signals based at least in part on the dispatch 138. Stated otherwise, the translation engine 140 can be configured to alter energy outputs of the load resource 112 and the energy storage resource 114 based at least in part on energy inputs received by the hybrid controllable load resource 110 from the dispatch 138. In some embodiments, the translation engine 140 can be configured to distribute market awards from the dispatch 138 based at least in part on whether the market offer 134 is accepted or rejected.

As used herein, an operating setpoint can be a parameter for energy consumption, energy dispatch/discharge, energy output, or the like by a site of the electric grid 102. For example, an operating setpoint for the load resource 112, and embodiments herein, can determine an energy consumption of the load resource over a period of time. Similarly, an operating setpoint for the energy storage resource 114, and embodiments herein, can determine a location, amount, and duration of energy discharge from the energy storage resource. In some embodiments, the translation engine 140 can determine operating setpoints by determining an optimal value for an operating setpoint then communicating the optimal value to a site controller of the corresponding site so that the site controller can update the operating setpoint of the site to the optimal value. Alternatively, the translation engine 140 may directly update operating setpoints, in that the translation engine 140 may be configured to alter operating setpoints of the hybrid controllable load resource 110. In this way, the translation engine 140 can update operating setpoints by determining values for the operating setpoints and either directly altering the operating setpoint of the site or communicating the value to the site controller of the site for the site controller to update the operating setpoint.

Accordingly, the translation engine 140 can be configured to determine a load operating setpoint 142 for the load resource 112. Stated otherwise, the translation engine 140 can be configured to output a signal to the load resource 112, the signal including the load operating setpoint 142. The load operating setpoint 142 can be referred to herein as an optimal load operating setpoint, as the translation engine 140 can determine the load operating setpoint 142 based at least in part on an optimization of an available load capacity, the real-time demand data 116, and the like. Additionally, the load operating setpoint 142 can be determined based at least in part on forecasted and real-time health and state of charge data of the energy storage resource 114. As can be appreciated, the load operating setpoint 142 can be in the form of a signal received by a site controller of the load resource 112, to which the site controller can be configured to update a previous load operating setpoint for the load resource 112 to the load operating setpoint 142 (or optimal load operating setpoint) determined by the translation engine 140.

The translation engine 140 can be configured to determine an energy storage operating setpoint 144 for the energy storage resource 114. Stated otherwise, the translation engine 140 can be configured to output a signal to the energy storage resource 114, the signal containing the energy storage operating setpoint 144. The energy storage operating setpoint 144 can be referred to herein as an optimal energy storage operating setpoint, as the translation engine 140 can determine the energy storage operating setpoint 144 based at least in part on an optimization of a current state of charge, a forecasted state of charge, the real-time health and state of charge data 118, and the like. Additionally, the energy storage operating setpoint 144 can be determined based at least in part on forecasted and real-time demand and capacity of the load resource 112. As can be appreciated, the energy storage operating setpoint 144 can be in the form of a signal received by a site controller of the energy storage resource 114, to which the site controller can be configured to update a previous energy storage operating setpoint for the energy storage resource 114 to the energy storage operating setpoint 144 (or the optimal energy storage operating setpoint) determined by the translation engine 140.

In some embodiments, the load operating setpoint 142 and the energy storage operating setpoint 144 can be determined by the translation engine 140 based at least in part on each other. Stated otherwise, the load operating setpoint 142 and the energy storage operating setpoint 144 can be determined together based at least in part on the energy volume of the dispatch 138 and the load demand at the load resource 112. As a non-limiting example, the load resource 112 can receive a dispatch 138 having a volume of energy less than a current load demand of the load resource 112, and the translation engine 140 can determine the load operating setpoint 142 to be the volume of the dispatch 138 and the energy storage operating setpoint 144 to be a difference between the current load demand and the volume of the dispatch 138. In this way, the translation engine 140 can determine the load operating setpoint 142 and the energy storage operating setpoint 144 such that a load demand, or current load demand, of the load resource 112 is met without setting the energy storage operating setpoint 144 above a threshold based on the health and state of charge of the energy storage resource 114. In another non-limiting example, if the dispatch 138 indicates a curtailed load for the load resource 112 (or a volume less than a previous volume received by the load resource), the translation engine 140 can be configured to update the energy storage operating setpoint 144 to supplement the difference in load between the dispatch 138 and the load demand. In this way, the translation engine 140 can be configured to dynamically update the load operating setpoint 142 and the energy storage operating setpoint 144 based at least in part on the dispatch 138 from the grid operator 104.

The optimization system 130 can further include a data repository 136. The data repository 136 can include any data storage device, database, or computing device discussed herein configured to store, at least temporarily, the input data 120, the market offer 134, the dispatch 138, the load operating setpoint 142, the energy storage operating setpoint 144, whether the market offer 134 was accepted or rejected by the grid operator 104 (sometimes referred to herein as an “outcome”), the real-time demand data 116, the real-time health and state of charge data 118, or any combination thereof. That is, the data repository 136 can be configured to store historical data including previous input data, previous market offers, previous outcomes associated with the previous market offers, previous dispatches associated with the previous outcomes, previous load demand, previous health and state of charge data, and the like. In this way, the offer generation system 132 can be configured to generate the market offer 134 based at least in part on historical data. Additionally, the translation engine 140 can be configured to determine the load operating setpoint 142 and the energy storage operating setpoint 144 based at least in part on historical data.

The system 100, although not shown, can include an application that can be in communication with the user interface and a machine learning model. As non-limiting examples, the application can be an extension of a browser, a software program, a program or feature of a kernel of the system, or any computer application that can perform the functions described herein.

As will be appreciated, as the machine learning model is trained and becomes more accurate over time, the amount of frequency of input data or the input data 120 can be reduced. In other words, as the machine learning model becomes more accurate over time, the need for human oversight of the machine learning model can decrease and the machine learning model can operate largely unsupervised.

The machine learning model can be or include a neural network, a recurrent neural network, a Long Short-Term Memory (LSTM) network, a bi-direction LSTM network, a Conditional Random Fields (CRF) network, an LSTM-CRF network, a Bi-LSTM-CRF network, or other suitable machine learning models. In some embodiments, the machine learning model can employ a gradient boosting model, a light gradient boosting model, or similar models known in the art.

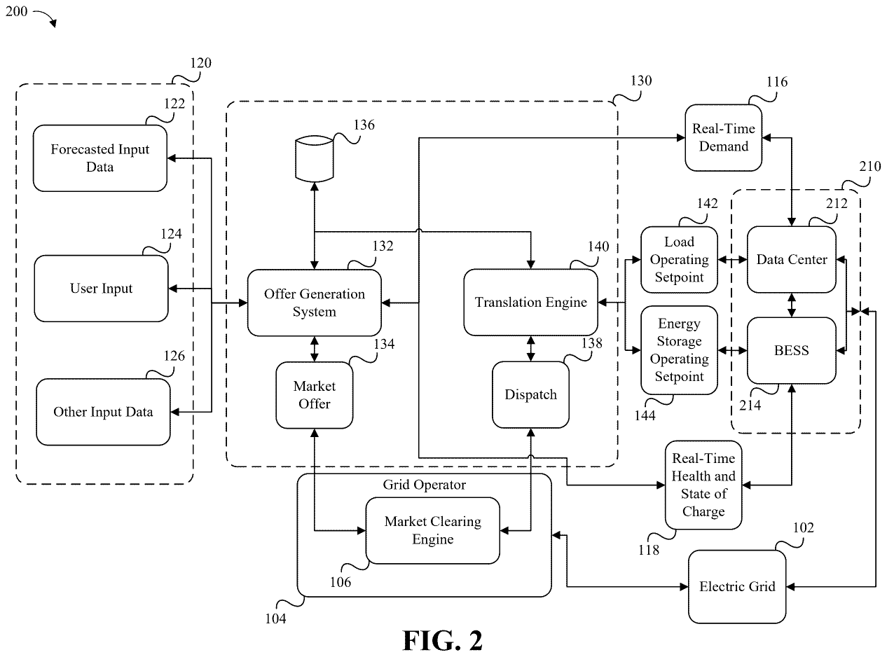

FIG. 2 illustrates a system 200 for operating a hybrid controllable load resource 210 of the electric grid 102. One of skill in the art will appreciate that the various features of the system 200 described herein can be incorporated into a single computing device or be divided into distinct parts across a network of computing devices. Thus, although the various features of the system 200 may be described as separate and distinct features or components, the described technology is not so limited.

The system 200 can include the electric grid 102 and the grid operator 104 of the electric grid 102. As discussed herein, the grid operator 104 can have the market clearing engine 106. That is, the grid operator 104 can have an ancillary service market clearing engine configured to receive ancillary service offers and distribute ancillary services based on accepting or rejecting the ancillary service offers. In this way, the grid operator 104 can be configured to receive ancillary service offers and determine, via the ancillary service market clearing engine, ancillary service dispatches based on the ancillary service offers.

The system 200 can include the hybrid controllable load resource 210. The hybrid controllable load resource 210 can include any embodiments of the hybrid controllable load resource 110 discussed herein. Further, the hybrid controllable load resource 210 can include a data center 212. The data center 212 can include any embodiments of the load resource 112 discussed herein, such that the data center 212 may include any examples of data centers as understood herein. The data center 212 can be a controllable load resource, in that the data center 212 can be configured to have an operating setpoint be dynamically adjusted based on market awards, or dispatches, from the grid operator 104. The hybrid controllable load resource 210 can include a battery energy storage system, referred to herein as a BESS 214. The BESS 214 can include any embodiments of the energy storage resource 114 discussed herein, and the BESS 214 may include any examples of battery energy storage systems understood herein. The BESS 214 can be electrically connected to the data center 212 such that the BESS 214 can provide energy to the data center 212. In some embodiments, the BESS 214 and the data center 212 can be collocated. In this way, the hybrid controllable load resource 210 can be configured to operate under a single meter, in that the data center 212 and the BESS 214 can be electrically connected under a single meter. In this way, the data center 212 and the BESS 214 can be considered, in combination, a controllable load resource, such that the hybrid controllable load resource 210 can be considered a controllable load resource for operating within the energy market, demand-response market, and/or the ancillary service market.

The data center 212 can be configured to generate the real-time demand data 116 based on real-time conditions of the data center 212. Similarly, the BESS 214 can be configured to generate real-time health and state of charge data 118 based on real-time conditions of the BESS 214.

The system 200 can include an optimization system 130 configured to receive the input data 120. Additionally, the optimization system 130 can include the data repository 136. Accordingly, the optimization system 130 can include an offer generation system 132 configured to generate the market offer 134 and submit the market offer 134 to the market clearing engine 106. As can be appreciated, the hybrid controllable load resource 210 can be configured to provide ancillary services to the electric grid 102. Ancillary services, as discussed herein, can include frequency regulation, spinning reserve, non-spinning reserve, voltage support, black start capability, load following, and similar services provided to the electric grid 102 to improve stability of the electric grid 102, as understood by those skilled in the art. In this way, the offer generation system 132 can generate an ancillary service offer as part of one or more offers included in the market offer 134. As understood herein, the market offer 134 can include an offer for an energy market, demand-response market, ancillary service market, or any combination thereof. For example, the ancillary service offer can include a volume (in some embodiments in MW), a price (in some embodiments in dollars), and an indication of the type of ancillary service being offered.

The offer generation system 132 can submit the market offer 134 to the market clearing engine 106 of the grid operator 104. The market clearing engine 106, in some embodiments, can include clearing engines for any of the markets discussed herein. For example, the market clearing engine 106 can include an electricity market clearing engine for the energy market, an ancillary service market clearing engine for the ancillary service market, and a demand-response market clearing engine for the demand-response market. In this way, the offer generation system 132 can be configured to generate an energy market offer, an ancillary service offer, a demand-response offer, or any combination thereof. Stated otherwise, the market offer 134 can include one or more offers for any combination of the energy market, the ancillary service market, and the demand-response market. Accordingly, the market clearing engine 106 dispatch 138 can output the dispatch 138 including one or more dispatches for any combination of the energy market, the ancillary service market, and the demand-response market. As can be appreciated, the market awards of the dispatch 138 can be based on the markets for which the one or more offers of the market offer 134 was submitted.

The optimization system 130 can include a translation engine 140. The translation engine 140 can include any embodiments of the translation engine 140 discussed herein. That is, the translation engine 140 can be configured to receive dispatches. For example, the translation engine 140 can receive the dispatch 138 from the market clearing engine 106. In some embodiments, the dispatch 138 can include market awards from the market clearing engine 106 based on an acceptance or rejection of the market offer 134. That is, the dispatch 138 can include an electric load value at a price, the electric load value and the price being based at least in part on the acceptance or rejection of the market offer 134. In some embodiments, the dispatch 138 can include a load curtailment, in that the dispatch 138 can indicate a load value for the hybrid controllable load resource 210 to decrease by. Alternatively, the dispatch 138 can include a load increase, in that the dispatch 138 can indicate a load value for the hybrid controllable load resource 210 to increase by. As can be appreciated, the dispatch 138 can include a requested load for the hybrid controllable load resource 210 to operate at.

The translation engine 140 can be configured to determine the load operating setpoint 142 for the data center 212 and the energy storage operating setpoint 144 for the BESS 214 based at least in part on the dispatch 138. As understood herein, the load operating setpoint 142 can include a load value for the data center 212 to operate at for a duration of time. Similarly, the energy storage operating setpoint 144 can include an energy discharge value for the BESS 214 for a duration of time. In some embodiments, the load operating setpoint 142 and the energy storage operating setpoint 144 can be determined based at least in part on meeting load requirements from the dispatch 138 and demand from the one or more customers of the data center 212. In some embodiments, the dispatch 138 can include a load dispatch, which may include a request for load curtailment, a market award of increased load from the electric grid 102, or the like. As a non-limiting example, the dispatch 138 may request a load curtailment for the hybrid controllable load resource 210, where the load curtailment would put the data center 212 below an operating setpoint needed to meet demand. In the non-limiting example, the translation engine 140 can decrease the load operating setpoint 142 to comply with the load curtailment, and update the energy storage operating setpoint 144 to reflect an increase discharge of power from the BESS 214 to the data center 212. That is, the BESS 214 can be configured to supplement a load demand of the data center 212 so that the hybrid controllable load resource 210 can comply with the load dispatch while meeting the load demand of the data center 212. In this way, the translation engine 140 can be configured to generate the load operating setpoint 142 and the energy storage operating setpoint 144 based on the load demand of the data center 212 and the market awards from the dispatch 138.

Further, the translation engine 140 can determine the energy storage operating setpoint 144 based at least in part on the dispatch 138. Accordingly, the dispatch 138 can include an ancillary service dispatch, which may include one or more market awards and/or requests to provide ancillary services. As understood herein, market awards for ancillary services can be based on an ancillary service offer of the market offer 134, or put otherwise, if the market offer 134 includes an offer of ancillary services for the hybrid controllable load resource 210. As can be appreciated, the BESS 214 of the hybrid controllable load resource 210 can be configured to provide ancillary services to the electric grid 102. That is, the translation engine 140 can update the energy storage operating setpoint 144 to include an ancillary service requested from the dispatch 138. As a non-limiting example, the dispatch 138 can include a requested voltage output from the hybrid controllable load resource 210. In the non-limiting example, the energy storage operating setpoint 144 can be updated to reflect a discharge amount from the BESS 214 to comply with the requested voltage output from the dispatch 138. In this way, the energy storage operating setpoint 144 can include a discharge amount to the grid operator 104 and/or electric grid 102 for ancillary services, and a discharge amount to the data center 212 to supplement the load demand of the data center 212.

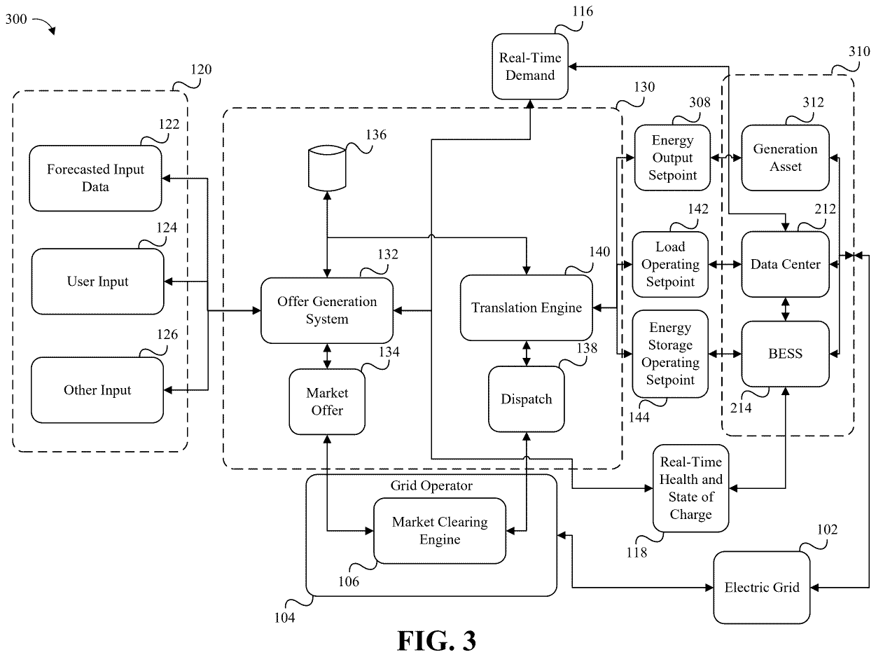

FIG. 3 illustrates a system 300 for operating a hybrid controllable load resource 310 of the electric grid 102. The system 300 can include a grid operator 104 of the electric grid 102. As discussed herein, the grid operator 104 can include the market clearing engine 106. In some embodiments, the market clearing engine 106 can include at least one of an electricity market clearing engine and an ancillary service market clearing engine. In other embodiments, the market clearing engine 106 can include an electricity market clearing engine and an ancillary market clearing engine. As can be appreciated, the market clearing engine 106 can include a platform for submitting electricity bids, electricity offers, ancillary service bids, ancillary service offers, etc. According to some embodiments, the market clearing engine 106 can include a plurality of market clearing engines used for a plurality of markets; the plurality of markets can include an energy generation market, demand-response market, day-ahead market, real-time market, capacity market, etc.

The system 300 can include a hybrid controllable load resource 310. The hybrid controllable load resource 310 can include any embodiments of the hybrid controllable load resource 110 and the hybrid controllable load resource 210 discussed herein. That is, the hybrid controllable load resource 310 can include the data center 212 and the BESS 214. Additionally, the hybrid controllable load resource 310 can include a generation asset 312 configured to produce electric power. The generation asset 312 can include any examples of sites in an electric grid configured to generate energy, as understood by those skilled in the art. For example, the generation asset 312 can include a power plant, nuclear plant, hydroelectric plant, wind farm, solar plant, geothermal plant, biomass plant, fossil fuel plant, or similar energy generation sites. The generation asset 312 can be electrically connected to the data center 212 and/or the BESS 214. In some embodiments, the generation asset 312 can be electrically connected to the data center 212 and the BESS 214, such that the generation asset 312 can be configured to produce electric power to be stored by the BESS 214 and/or supplement load for the use of the data center 212. According to some embodiments, the generation asset 312 can be collocated with the data center 212 and/or the BESS 214, such that the generation asset 312, the data center 212, and the BESS 214 can operate under a single meter. As understood herein, the data center 212 can be configured to produce the real-time demand data 116. Further, the BESS 214 can be configured to produce the real-time health and state of charge data 118.

The system 300 can include an optimization system 130 configured to receive the input data 120. As discussed herein, the optimization system 130 can include the data repository 136. As shown, the optimization system 130 can include the offer generation system 132 configured to generate the market offer 134 based at least in part on any combination of the input data 120, the real-time demand data 116, and/or the real-time health and state of charge data 118. As previously discussed, the market offer 134 can include an offer for an energy market, demand-response market, ancillary service market, or any markets of similar contexts as understood herein. In some embodiments, the market offer 134 can include multiple offers for multiple markets. As understood by those skilled in the art, one or more offers can be made to respective markets for the hybrid controllable load resource 310. For example, a system (e.g., the offer generation system 132) of the hybrid controllable load resource 310 can make offers for buying and selling energy from the generation asset 312, adjusting load according to a demand-response market for the data center 212, and providing ancillary services via the BESS 214. In this way, the offer generation system 132 can generate one or more offers including the market offer 134.

The offer generation system 132 can be configured to submit the market offer 134 to the market clearing engine 106. As can be appreciated, submitting the market offer 134 to the clearing engine can include submitting the market offer 134 to an offer portal of the grid operator 104, and the grid operator 104 or computing device, network, and/or system of the grid operator 104 can input the market offer 134 to the market clearing engine 106. The market clearing engine 106, as discussed for other embodiments herein, can accept or reject the offer by employing a method of market clearing, as understood by those skilled in the art. In some embodiments, if the market offer 134 includes multiple offers for multiple markets, the market clearing engine 106 can submit each offer to their respective market clearing engine and produce an acceptance or rejection associated with each offer.

As can be appreciated, acceptance and rejection of the market offer 134 can result in market awards in the form of the dispatch 138. That is, the market clearing engine 106 can be configured to generate the dispatch 138 including market awards based on the market offer 134. For example, if the market offer 134 includes an ancillary service offer and a market offer for a demand-response market or electricity market, the dispatch 138 can include a load dispatch, an ancillary service dispatch, and/or a demand-response dispatch based on an outcome of respective offers in the market clearing method of the market clearing engine 106. As discussed for other embodiments herein, the dispatch 138 can include a request to produce electricity, a request to adjust load consumption, a request for ancillary services, or the like.

The system 300 can include the translation engine 140 configured to receive the dispatch 138 and update operating setpoints for the hybrid controllable load resource 310. The load operating setpoint 142 can be an optimal load operating setpoint, in that the translation engine 140 can be configured to generate the optimal load operating setpoint based on the dispatch 138 and communicate the optimal load operating setpoint to the data center 212 in such a way that the data center 212 can update setpoints for one or more operations to the optimal load operating setpoint. Similarly, the energy storage operating setpoint 144 can be an optimal BESS operating setpoint, in that the translation engine 140 can be configured to generate the optimal BESS operating setpoint based on the dispatch 138 and communicate the optimal BESS operating setpoint to the BESS 214 in such a way that the BESS 214 can update the setpoints for one or more operations to the optimal BESS operating setpoint.

Additionally, the translation engine 140 can be configured to generate an energy output setpoint 308 based on the dispatch 138. Stated otherwise, the dispatch 138 can include market rewards for an electricity market, in that the dispatch 138 may include market awards indicating a volume and price of electricity to be produced by the hybrid controllable load resource 310. As understood herein, the hybrid controllable load resource 310, via the generation asset 312, can have offers for the sale of energy produced by the generation asset 312. In this way, the dispatch 138 can include market awards related to the sale of electricity produced by the generation asset 312. The energy output setpoint 308 can be communicated by the translation engine 140 to the generation asset 312 to determine an energy output of the generation asset 312 to the electric grid 102 based on the dispatch 138. In some embodiments, the energy output setpoint 308 can include a setpoint for the energy output of the generation asset 312 to the data center 212, in that the energy output setpoint 308 can define an amount of electric power being transferred to the data center 212 by the generation asset 312. As a non-limiting example, for any given period in time, the data center 212 may require a larger load volume than can be provided via market awards and/or discharge from the BESS 214. In the non-limiting example, this may occur due, at least in part, to real-time demand of the data center 212. In this way, the generation asset 312 can be configured to supplement the load demand of the data center 212 by producing and transferring electric power to the data center 212; the volume and duration of electric power transferred can be determined, in some embodiments, by the energy output setpoint 308 from the translation engine 140. Similar to embodiments of the load operating setpoint 142 and the energy storage operating setpoint 144, the energy output setpoint 308 can be an optimal energy output setpoint, in that the translation engine 140 can be configured to generate the optimal energy output setpoint and communicate the optimal energy output setpoint to the generation asset 312 in such a way that the generation asset 312 can update setpoints for one or more operations based on the energy output setpoint.

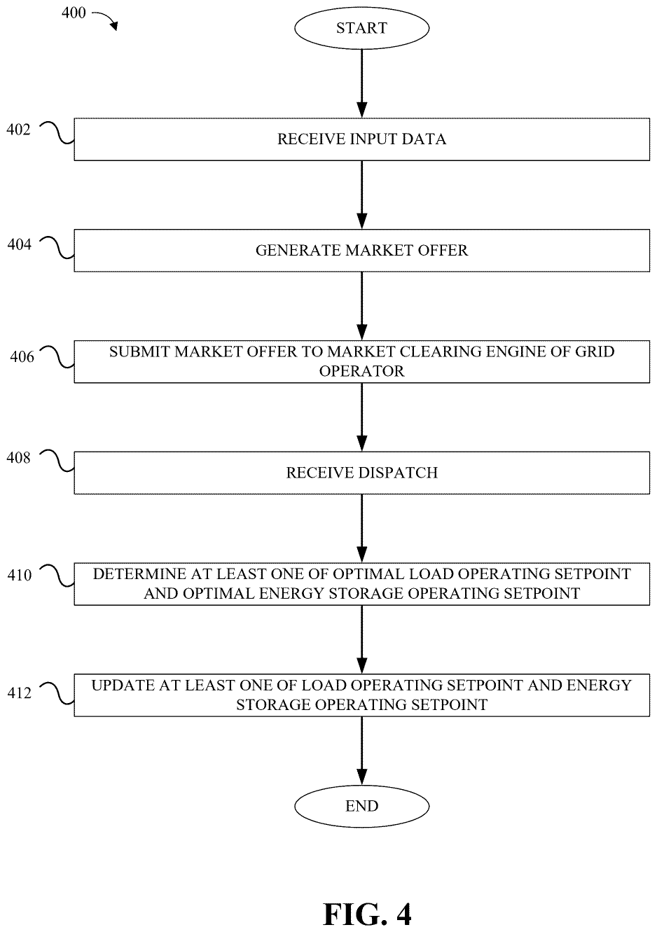

FIG. 4 is a flow diagram illustrating a method 400 for operating a hybrid controllable load resource of an electric grid. As can be appreciated, the hybrid controllable load resource can include any embodiments of the hybrid controllable load resource 110, the hybrid controllable load resource 210, and the hybrid controllable load resource 310, as discussed herein. Additionally, the electric grid can include any embodiments of the electric grid 102 discussed herein. The hybrid controllable load resource can include a load resource (e.g., the load resource 112) and an energy storage resource (e.g., the energy storage resource 114). For example, the load resource can be a data center (e.g., the data center 212), and the energy storage resource can be a BESS (e.g., the BESS 214).

The method 400 can include receiving 402 input data. The input data can include any embodiments of the input data 120 discussed herein, in that the input data can include the forecasted input data 122, the user input 124, the user-determined constraints, the other input data 126, or any combination thereof. That is, the method 400 can include receiving user input which, in some embodiments, can be in the form of the user input 124 and/or the user-determined constraints. Although not shown, some embodiments of the method 400 may include generating forecasted input data (e.g., the forecasted input data 122).

The method 400 can include generating 404 a market offer. The market offer can include any embodiments of the market offer 134 discussed herein. That is, the market offer can be part of one or more market offers or a plurality of market offers for one or more markets, including any examples of markets discussed herein. For example, the market offer can be for an energy market, electricity market, demand-response market, ancillary market, or the like. The market offer can be generated using any systems for generating offers (e.g., the offer generation system 132 of the optimization system 130) discussed herein. The market offer can be generated based at least in part on the input data. As discussed herein, the market offer can be generated based on real-time data from the load resource and/or the energy storage resource (e.g., the real-time demand data 116 and the real-time health and state of charge data 118). In some embodiments, the market offer can be based on historical data, including any embodiments of historical data discussed herein (e.g., historical data stored by the data repository 136). The market offer can include a volume and price, such that generating the market offer can include generating a volume and price for the market offer. As discussed herein the volume can be based on a market the market offer is being generated for; for example, the volume can be a volume of electricity to be sold over a given time, a volume of load to be received by the hybrid controllable load resource, a volume of energy needed at a given frequency for an ancillary service, or similar contexts as understood herein.

The method 400 can include submitting 406 the market offer to a market clearing engine of a grid operator. The grid operator can include any embodiments of the grid operator 104 discussed herein, and the market clearing engine can include any embodiments of the market clearing engine 106 discussed herein. That is, the market clearing engine can receive market offers for one or more markets and execute market decisions, in some cases being a market clearing decision, as understood herein. As can be appreciated, the market clearing engine can be for a market of the market offer, which may include any examples of markets discussed herein. Submitting 406 the market offer to the market clearing engine can include submitting the market offer to an offer portal of the grid operator, the offer portal being configured to include the market offer in a market clearing decision of the market clearing engine. As discussed herein, the market offer can be submitted to the market clearing engine by communicating the market offer in the form of a signal, the signal being transmitted to one or more computing devices, networks, or the like by one or more computing devices, networks, or the like, as will be discussed in greater detail herein.

The method 400 can include receiving 408 a dispatch. The dispatch can include any embodiments of the dispatch 138 discussed herein. As understood herein, the dispatch can be generated by the market clearing engine of the grid operator, such that the market clearing engine can output the dispatch based on a market clearing decision for the market offer. As will be discussed in greater detail herein, some embodiments of the dispatch can include an offer acceptance or an offer rejection, in that the market clearing engine can accept or reject the market offer and communicate the acceptance or rejection of the market offer to the hybrid controllable load resource, or any associated systems (e.g., the optimization system 130, the offer generation system 132, and the translation engine 140). In some embodiments, the market clearing engine can output the dispatch if the offer is accepted, in that the dispatch can include market awards from the offer acceptance. In some embodiments, the market clearing engine can output the dispatch whether the offer is accepted or rejected, the dispatch including market awards for an offer acceptance or one or more instructions and an offer rejection.

The method 400 can include determining 410 at least one of an optimal load operating setpoint and an optimal energy storage operating setpoint. The optimal load operating setpoint and the optimal energy storage operating setpoint can be in the form of values for a load operating setpoint (e.g., the load operating setpoint 142) and an energy storage operating setpoint (e.g., the energy storage operating setpoint 144), respectively. That is, determining the optimal load operating setpoint can include determining the load operating setpoint for the load energy resource, and determining the optimal energy storage operating setpoint can include determining the energy storage operating setpoint for the energy storage resource. The optimal load operating setpoint and the optimal energy storage operating setpoint can be determined by any embodiments of the translation engine 140 discussed herein. Accordingly, the optimal load operating setpoint and the optimal energy storage operating setpoint can be determined based at least in part on the input data, the dispatch, one or more user-determined constraints, etc.

The method 400 can include updating 412 at least one of a load operating setpoint and an energy storage operating setpoint. The load operating setpoint can include any embodiments of the load operating setpoint 142 discussed herein, and the energy storage operating setpoint can include any embodiments of the energy storage operating setpoint 144 discussed herein. That is, the load operating setpoint can be a setpoint for the load resource determining an energy consumption (or load) of the load resource. Similarly, the energy storage operating setpoint can be a setpoint for the energy storage resource determining an energy discharge location and volume for the energy storage resource. In this way, updating 412 at least one of the load operating setpoint and the energy storage operating setpoint can include communicating at least one of the optimal load operating setpoint and the optimal energy storage operating setpoint to a site controller of at least one of the load resource and the energy storage resource. For example, the load operating setpoint of the load resource can be updated by receiving the optimal load operating setpoint at a site controller of the load resource and altering the load operating setpoint of the load resource via the site controller. In this way, the load operating setpoint of the load resource can be updated to the optimal load operating setpoint. Similarly, the energy storage operating setpoint of the energy storage resource can be updated by receiving the optimal energy storage operating setpoint at a site controller of the energy storage resource and altering the energy storage operating setpoint of the energy storage resource via the site controller. In this way, the energy storage operating setpoint of the energy storage resource can be updated to the optimal energy storage operating setpoint.

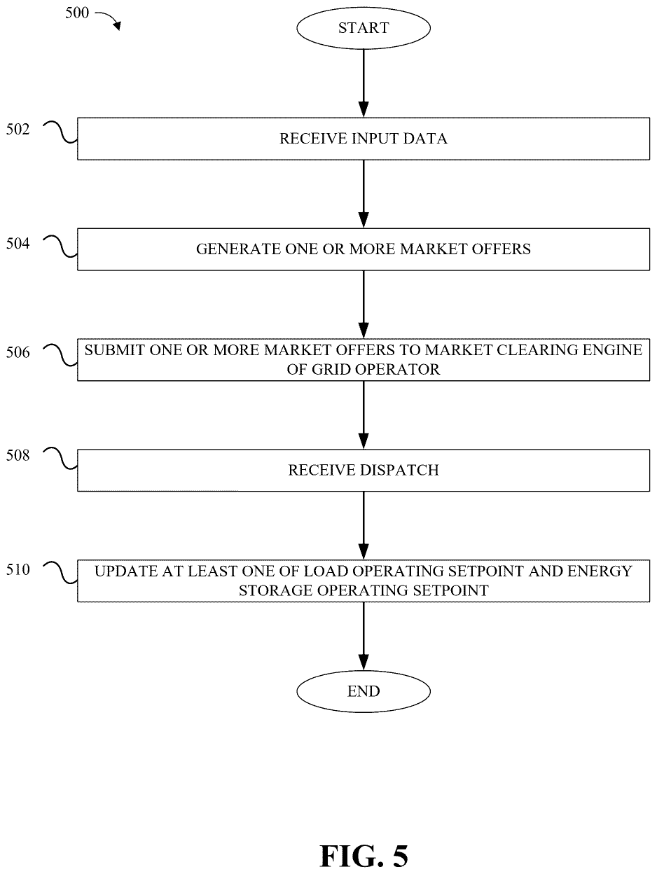

FIG. 5. is yet another flow diagram illustrating a method 500 for operating a hybrid controllable load resource. As can be appreciated, the hybrid controllable load resource can include any embodiments of the hybrid controllable load resource 110, the hybrid controllable load resource 210, and the hybrid controllable load resource 310, as discussed herein. Additionally, the electric grid can include any embodiments of the electric grid 102 discussed herein. The hybrid controllable load resource can include a load resource (e.g., the load resource 112) and an energy storage resource (e.g., the energy storage resource 114). For example, the load resource can be a data center (e.g., the data center 212), and the energy storage resource can be a BESS (e.g., the BESS 214).

As before, the method 500 can include receiving 502 input data. The method 500 can further include generating 504 one or more market offers. As can be appreciated, the one or more market offers can include one or more embodiments of the market offer 134 discussed herein. That is, the one or more market offers can be for one or more markets, as understood herein.

The method 500 can include submitting the one or more market offers to a market clearing engine of a grid operator. The grid operator can include any embodiments of the grid operator 104 discussed herein, and the market clearing engine can include any embodiments of the market clearing engine 106 discussed herein. That is, the market clearing engine can be for one or more markets, in that the market clearing engine can receive one or more market offers for one or more markets. In some embodiments, the one or more market offers can be part of a plurality of offers for a plurality of markets submitted to the market clearing engine of the grid operator. In this way, the one or more market offers can include a demand-response offer, an ancillary service offer, and/or an energy market offer.

As before, the method 500 can include receiving 508 the dispatch. In some embodiments, the dispatch can include one or more dispatches for one or more markets. For example, if the one or more market offers include market offers for a demand-response market, an ancillary service market, and/or an energy market, the dispatch can include an acceptance or rejection for each of the submitted market offers. Accordingly, the dispatch can include a load dispatch, an ancillary service dispatch, an energy dispatch, etc. depending on an outcome of a market clearing method for accepting or rejecting the one or more market offers.

Additionally, the method 500 can include updating 510 at least one of a load operating setpoint and an energy storage operating setpoint. The load operating setpoint can include any embodiments of the load operating setpoint 142 discussed herein, and the energy storage operating setpoint can include any embodiments of the energy storage operating setpoint 144 discussed herein. That is, updating 510 at least one of the load operating setpoint and the energy storage operating setpoint can include determining at least one of the load operating setpoint for the load resource and the energy storage operating setpoint for the energy storage resource and communicating at least one of the load operating setpoint and the energy storage operating setpoint to the hybrid controllable load resource. As can be appreciated, communicating the load operating setpoint and/or the energy storage operating setpoint to the hybrid controllable load resource can include outputting a signal including the determined load operating setpoint or the determined energy storage operating setpoint to a site controller of the load resource or the energy storage resource, respectively. As understood herein, the load operating setpoint and the energy storage operating setpoint can be determined via any embodiments of the translation engine 140 discussed herein.

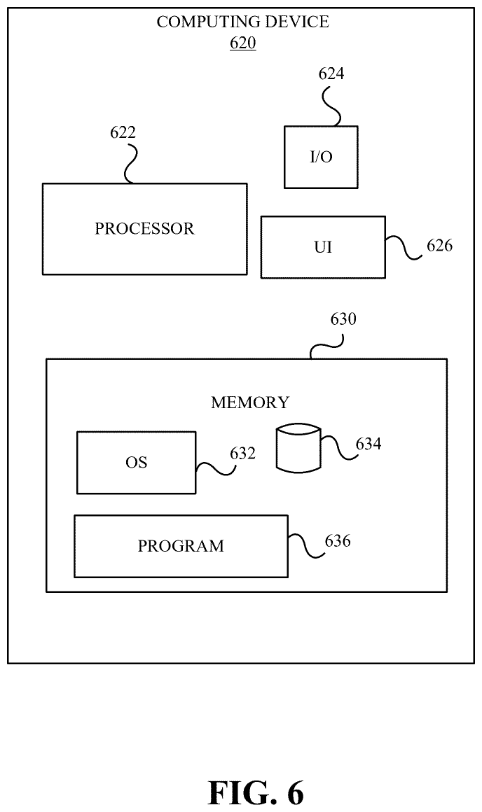

FIG. 6 illustrates an example computing device configured to operate a hybrid controllable load resource, in accordance with an example of the disclosed technology. As will be appreciated by one of skill in the art, the computing device 620 can be configured to include all or some of the features described in relation to the system 100. As shown, the computing device 620 may include a processor 622, an input/output (“I/O”) device 624, a memory 630 containing an operating system (“OS”) 632 and a program 636. In certain example implementations, the computing device 620 may be a single server or may be configured as a distributed computer system including multiple servers or computers that interoperate to perform one or more of the processes and functionalities associated with the disclosed embodiments. In some embodiments, computing device 620 may be one or more servers from a serverless or scaling server system. In some embodiments, the computing device 620 may further include a peripheral interface, a transceiver, a mobile network interface in communication with the processor 622, a bus configured to facilitate communication between the various components of the computing device 620, and a power source configured to power one or more components of the computing device 620.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 622 to communicate with other devices via wired or wireless networks, whether local or wide area, private or public, as known in the art. A power source may be configured to provide an appropriate alternating current (AC) or direct current (DC) to power components.

The processor 622 may include one or more of a microprocessor, microcontroller, digital signal processor, co-processor or the like or combinations thereof capable of executing stored instructions and operating upon stored data. The memory 630 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 630.

The processor 622 may be one or more known processing devices, such as, but not limited to, a microprocessor from the Pentium™ family manufactured by Intel™ or the Turion™ family manufactured by AMD™. The processor 622 may constitute a single core or multiple core processor that executes parallel processes simultaneously. For example, the processor 622 may be a single core processor that is configured with virtual processing technologies. In certain embodiments, the processor 622 may use logical processors to simultaneously execute and control multiple processes. The processor 622 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the computing device 620 may include one or more storage devices configured to store information used by the processor 622 (or other components) to perform certain functions related to the disclosed embodiments. In one example, the computing device 620 may include the memory 630 that includes instructions to enable the processor 622 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 620 may include a memory 630 that includes instructions that, when executed by the processor 622, perform one or more processes consistent with the functionalities disclosed herein. Methods, systems, and articles of manufacture consistent with disclosed embodiments are not limited to separate programs or computers configured to perform dedicated tasks. For example, the computing device 620 may include the memory 630 that may include one or more programs 636 to perform one or more functions of the disclosed embodiments.

The processor 622 may execute one or more programs located remotely from the computing device 620. For example, the computing device 620 may access one or more remote programs that, when executed, perform functions related to disclosed embodiments.

The memory 630 may include one or more memory devices that store data and instructions used to perform one or more features of the disclosed embodiments. The memory 630 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 630 may include software components that, when executed by the processor 622, perform one or more processes consistent with the disclosed embodiments. In some examples, the memory 630 may include a database 634 configured to store various data described herein. For example, the database 634 can be the data repository 136.

The computing device 620 may also be communicatively connected to one or more memory devices (e.g., databases) locally or through a network. The remote memory devices may be configured to store information and may be accessed and/or managed by the computing device 620. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 620 may also include one or more I/O devices 624 that may comprise one or more user interfaces 626 (e.g., user interface) for receiving signals or input from devices and providing signals or output to one or more devices that allow data to be received and/or transmitted by the computing device 620. For example, the computing device 620 may include interface components, which may provide interfaces to one or more input devices, such as one or more keyboards, mouse devices, touch screens, track pads, trackballs, scroll wheels, digital cameras, microphones, sensors, and the like, that enable the computing device 620 to receive data from a user.

In example embodiments of the disclosed technology, the computing device 620 may include any number of hardware and/or software applications that are executed to facilitate any of the operations. The one or more I/O devices 624 may be utilized to receive or collect data and/or user instructions from a wide variety of input devices. Received data may be processed by one or more computer processors as desired in various implementations of the disclosed technology and/or stored in one or more memory devices.

While the computing device 620 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 620 may include a greater or lesser number of components than those illustrated.

The disclosed technology can be further understood according to the following clauses:
Clause 1: A method for operating a hybrid controllable load resource, comprising: receiving input data comprising energy market price forecast data, ancillary service market price forecast data, load forecast data, peak demand forecast data, transmission cost forecast data, real-time demand data from a load resource, real-time health data from an energy storage resource, real-time state of charge data from the energy storage resource, or any combination thereof; generating a market offer based at least in part on the input data; submitting the market offer to a market clearing engine of a grid operator; receiving a dispatch from the market clearing engine; determining at least one of an optimal load operating setpoint and an optimal energy storage operating setpoint based at least in part on the dispatch; and updating at least one of a load operating setpoint of the load resource to the optimal load operating setpoint and an energy storage operating setpoint of the energy storage resource to the optimal energy storage operating setpoint.
Clause 2: The method of Clause 1, wherein the hybrid controllable load resource comprises the load resource and the energy storage resource, the load resource and the energy storage resource being collocated and electrically connected.
Clause 3: The method of Clause 2, wherein the hybrid controllable load resource operates under a single meter, the energy storage resource being a behind-the-meter resource.
Clause 4: The method of Clause 1, wherein receiving the dispatch from the market clearing engine comprises at least one of: receiving an offer acceptance comprising a load dispatch; and receiving an offer rejection.
Clause 5: The method of Clause 4, wherein determining at least one of the optimal load operating setpoint and the optimal energy storage operating setpoint comprises: determining the optimal load operating setpoint based at least in part on the input data, the load dispatch, the one or more user-determined constraints, or any combination thereof; and determining the optimal energy storage operating setpoint based at least in part on the optimal load operating setpoint, the input data, the load dispatch, one or more user-determined constraints, or any combination thereof.
Clause 6: The method of Clause 1, further comprising: generating an ancillary service offer based on the input data; submitting the ancillary service offer to an ancillary service market clearing engine; receiving an ancillary service dispatch from the ancillary service market clearing engine; and updating the energy storage operating setpoint of the energy storage resource based at least in part on the ancillary service dispatch.
Clause 7: The method of Clause 1, wherein the market offer is determined further based at least in part on user specified risk, physical limitations of electrical interconnection, power output levels, energy output levels, ramp rates, resource operating procedures, grid operator regulations, or any combination thereof.
Clause 8: A system for a hybrid controllable load resource of an electric grid, in which a data center is electrically connected to the electric grid and configured to dynamically alter a load based at least in part on a dispatch from a grid operator and a battery energy storage system (BESS) is electrically connected to the data center and configured to provide ancillary services to the electric grid, the system comprising: an offer generation system configured to generate a market offer based at least in part on a real-time demand of the data center, real-time health of the BESS, real-time state of charge of the BESS, or any combination thereof; and a translation engine configured to update a load operating setpoint of the data center and an energy storage operating setpoint of the BESS based at least in part on the dispatch.
Clause 9: The system of Clause 8, wherein the data center and the BESS are collocated.
Clause 10: The system of Clause 9, wherein the data center and the BESS operate under a single meter, the BESS being a behind-the-meter resource.
Clause 11: The system of Clause 8, wherein the dispatch comprises at least one of: an offer acceptance comprising a load dispatch; and an offer rejection.
Clause 12: The system of Clause 11, wherein the translation engine is configured to update the load operating setpoint and the energy storage operating setpoint based at least in part on whether the market offer is accepted or rejected, the load dispatch, forecasted input data, a current load operating setpoint of the data center, a current energy storage operating setpoint of the BESS, or any combination thereof.
Clause 13: The system of Clause 8, wherein the offer generation system is further configured to generate an ancillary service offer, and the translation engine is further configured to update the energy storage operating setpoint based at least in part on an ancillary service dispatch.
Clause 14: The system of Clause 8, wherein the dispatch includes a load adjustment value, the data center and the BESS being configured to contribute, at least partially, to the load adjustment value.
Clause 15: The system of Clause 8, further comprising a generation asset configured to generate energy, the generation asset being collocated with the hybrid controllable load resource and electrically connected to the electric grid.
Clause 16: A method for operating a hybrid controllable load resource of an electric grid, comprising: receiving input data comprising: forecasted input data comprising energy market price forecast data, ancillary services market price forecast data, data center load forecast data, peak demand forecast data, transmission cost forecast data, or any combination thereof; real-time demand data of a data center of the hybrid controllable load resource; real-time health data of a battery energy storage system (BESS) of the hybrid controllable load resource; and real-time state of charge data of the BESS; generating one or more market offers based at least in part on the input data, the one or more market offers comprising at least one of a market offer for an energy market and an ancillary service offer for an ancillary service market; submitting the one or more market offers to one or more market clearing engines of a grid operator; receiving a dispatch comprising at least one of a load dispatch and an ancillary service dispatch; and updating at least one of a load operating setpoint of the data center and an energy storage operating setpoint of the BESS based at least in part on at least one of the load dispatch and the ancillary service dispatch.
Clause 17: The method of Clause 16, wherein the data center and the BESS are collocated and electrically connected.
Clause 18: The method of Clause 17, wherein the hybrid controllable load resource operates under a single meter, the BESS being a behind-the-meter resource.
Clause 19: The method of Clause 16, further comprising updating an energy output of a collocated generator of the hybrid controllable load resource based at least in part on the dispatch.
Clause 20: The method of Clause 19, wherein the input data further includes real-time energy output of the collocated generator, forecasted energy output of the collocated generator, physical limitations of electrical interconnections, power output levels of the hybrid controllable load resource, energy output levels of the hybrid controllable load resource, ramp rates, resource operating procedures, grid operating regulations, or any combination thereof.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A method for operating a hybrid controllable load resource, comprising:
receiving input data comprising energy market price forecast data, ancillary service market price forecast data, load forecast data, peak demand forecast data, transmission cost forecast data, real-time demand data from a load resource, real-time health data from an energy storage resource, real-time state of charge data from the energy storage resource, or any combination thereof;
generating a market offer based at least in part on the input data;
submitting the market offer to a market clearing engine of a grid operator;
receiving a dispatch from the market clearing engine;
determining at least one of an optimal load operating setpoint and an optimal energy storage operating setpoint based at least in part on the dispatch; and
updating at least one of a load operating setpoint of the load resource to the optimal load operating setpoint and an energy storage operating setpoint of the energy storage resource to the optimal energy storage operating setpoint.

2. The method of claim 1, wherein the hybrid controllable load resource comprises the load resource and the energy storage resource, the load resource and the energy storage resource being collocated and electrically connected.

3. The method of claim 2, wherein the hybrid controllable load resource operates under a single meter, the energy storage resource being a behind-the-meter resource.

4. The method of claim 1, wherein receiving the dispatch from the market clearing engine comprises at least one of:
receiving an offer acceptance comprising a load dispatch; and
receiving an offer rejection.

5. The method of claim 4, wherein determining at least one of the optimal load operating setpoint and the optimal energy storage operating setpoint comprises:
determining the optimal load operating setpoint based at least in part on the input data, the load dispatch, one or more user-determined constraints, or any combination thereof; and
determining the optimal energy storage operating setpoint based at least in part on the optimal load operating setpoint, the input data, the load dispatch, the one or more user-determined constraints, or any combination thereof.

6. The method of claim 1, further comprising:
generating an ancillary service offer based on the input data;
submitting the ancillary service offer to an ancillary service market clearing engine;
receiving an ancillary service dispatch from the ancillary service market clearing engine; and
updating the energy storage operating setpoint of the energy storage resource based at least in part on the ancillary service dispatch.

7. The method of claim 1, wherein the market offer is determined further based at least in part on user specified risk, physical limitations of electrical interconnection, power output levels, energy output levels, ramp rates, resource operating procedures, grid operator regulations, or any combination thereof.

8. A system for a hybrid controllable load resource of an electric grid, in which a data center is electrically connected to the electric grid and configured to dynamically alter a load based at least in part on a dispatch from a grid operator and a battery energy storage system (BESS) is electrically connected to the data center and configured to provide ancillary services to the electric grid, the system comprising:
an offer generation system configured to generate a market offer based at least in part on a real-time demand of the data center, real-time health of the BESS, real-time state of charge of the BESS, or any combination thereof; and
a translation engine configured to update a load operating setpoint of the data center and an energy storage operating setpoint of the BESS based at least in part on the dispatch.

9. The system of claim 8, wherein the data center and the BESS are collocated.

10. The system of claim 9, wherein the data center and the BESS operate under a single meter, the BESS being a behind-the-meter resource.

11. The system of claim 8, wherein the dispatch comprises at least one of:
an offer acceptance comprising a load dispatch; and
an offer rejection.

12. The system of claim 11, wherein the translation engine is configured to update the load operating setpoint and the energy storage operating setpoint based at least in part on whether the market offer is accepted or rejected, the load dispatch, forecasted input data, a current load operating setpoint of the data center, a current BESS operating setpoint of the BESS, or any combination thereof.

13. The system of claim 8, wherein the offer generation system is further configured to generate an ancillary service offer, and the translation engine is further configured to update the energy storage operating setpoint based at least in part on an ancillary service dispatch.

14. The system of claim 8, wherein the dispatch includes a load adjustment value, the data center and the BESS being configured to contribute, at least partially, to the load adjustment value.

15. The system of claim 8, further comprising a generation asset configured to generate energy, the generation asset being collocated with the hybrid controllable load resource and electrically connected to the electric grid.

16. A method for operating a hybrid controllable load resource of an electric grid, comprising:
receiving input data comprising:
forecasted input data comprising energy market price forecast data, ancillary services market price forecast data, data center load forecast data, peak demand forecast data, transmission cost forecast data, or any combination thereof;
real-time demand data of a data center of the hybrid controllable load resource;
real-time health data of a battery energy storage system (BESS) of the hybrid controllable load resource; and
real-time state of charge data of the BESS;
generating one or more market offers based at least in part on the input data, the one or more market offers comprising at least one of a market offer for an energy market and an ancillary service offer for an ancillary service market;
submitting the one or more market offers to one or more market clearing engines of a grid operator;
receiving a dispatch comprising at least one of a load dispatch and an ancillary service dispatch; and
updating at least one of a load operating setpoint of the data center and an energy storage operating setpoint of the BESS based at least in part on at least one of the load dispatch and the ancillary service dispatch.

17. The method of claim 16, wherein the data center and the BESS are collocated and electrically connected.

18. The method of claim 17, wherein the hybrid controllable load resource operates under a single meter, the BESS being a behind-the-meter resource.

19. The method of claim 16, further comprising updating an energy output of a collocated generator of the hybrid controllable load resource based at least in part on the dispatch.

20. The method of claim 19, wherein the input data further includes real-time energy output of the collocated generator, forecasted energy output of the collocated generator, physical limitations of electrical interconnections, power output levels of the hybrid controllable load resource, energy output levels of the hybrid controllable load resource, ramp rates, resource operating procedures, grid operating regulations, or any combination thereof.
